(19) United States
(12) Patent Application Publication
(10) Pub. No.: US 2004/0075623 A1
(43) Pub. Date: Apr. 22, 2004

(54) Method and system for displaying images on multiple monitors

(75) Inventor: Jason Hartman, Woodinville, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 10/272,863

(22) Filed: Oct. 17, 2002

(51) Int. Cl. G09G 5/00

(52) U.S. Cl. 345/1.3

(57) ABSTRACT

A method and system for displaying images on a plurality of monitors that are linked to a computer is provided, in which the act of rendering of the images is performed by one or more graphics coprocessors rather than by the computer's central processing unit (CPU). The invention frees the CPU to perform other tasks as required by the various application programs that are running on the computer. Offloading the rendering functions to a graphics coprocessor allows various rendering optimization techniques to be implemented.

### TECHNICAL FIELD OF THE INVENTION

The invention relates generally to multiple monitor computer display techniques and, more specifically, such techniques that use the capabilities of graphics coprocessors.

### BACKGROUND

As the price and bulkiness of computer monitors has come down, consumers have increasingly been purchasing second and even third monitors for use with their computers. With multiple monitors, for example, a user can comfortably work on a document on one monitor, keep an email program open on another monitor, and even view stock market quotes on a third monitor.

Generally, each monitor of a computer is supported by a separate piece of hardware such as a graphics card. Modern graphics cards have become increasingly sophisticated, and many are capable of speeding up the process of displaying images on monitors through a class of techniques known as graphics acceleration. However, many computer programs are not capable of taking advantage of graphics acceleration in the context of multiple monitors. As a result, such programs often resort to using the computer's central processing unit (CPU) to perform many graphics functions that could otherwise be performed by one or more graphics cards.

### SUMMARY

In accordance with the foregoing, a method and system of displaying images on multiple monitors is provided herein. According to various embodiments of the invention, a computer maintains information regarding which portion of a window is to be displayed on a first monitor and which portion of the window is to be displayed on a second monitor, and delegates the tasks of rendering each portion of the window to respective graphics coprocessors. The graphics coprocessors then render both portions of the window in parallel.

In another embodiment of the invention, a computer cooperates with a single graphics device to display images on multiple monitors. The graphics device controls at least two monitors, and has a memory in which one portion is reserved for rendering images that are to be displayed on one of the monitors and another portion is reserved for rendering images that are to be displayed on another of the monitors. The graphics device also maintains a boundary between the two portions of memory, which can be moved as required to reflect movement of the images from one monitor to another.

Additional aspects of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention may be best understood from the following detailed description taken in conjunction with the accompanying drawings of which:

FIG. 1 illustrates an example of a computer network in which the invention may be practiced;

FIG. 2 illustrates an example of a computer on which at least some parts of the invention may be implemented;

FIG. 3 illustrates an example of a workspace that may be used in conjunction with an embodiment of the invention; and

FIGS. 4, 5, 6 and 7 show various embodiments of the invention.

### DETAILED DESCRIPTION

The invention is generally directed to a method and system for displaying images on a plurality of monitors that are linked to a computer, in which the act of rendering the images is performed by one or more graphics coprocessors rather than by the computer's central processing unit (CPU). Thus, the invention frees the CPU to perform other tasks as required by the various application programs that are running on the computer. Offloading the rendering functions to a graphics coprocessor allows various rendering optimization techniques to be implemented, as will be discussed below.

Prior to proceeding with a description of the various embodiments of the invention, a description of the computer and networking environment in which the various embodiments of the invention may be practiced will now be provided. Although it is not required, the present invention may be implemented by programs that are executed by a computer. Generally, programs include routines, objects, components, data structures and the like that perform particular tasks or implement particular abstract data types. The term “program” as used herein may connote a single program module or multiple program modules acting in concert. The term “computer” as used herein includes any device that electronically executes one or more programs, such as personal computers (PCs), hand-held devices, multi-processor systems, microprocessor-based programmable consumer electronics, network PCs, minicomputers, mainframe computers, consumer appliances that have microprocessors or microcontrollers, routers, gateways, hubs and the like. The invention may also be employed in distributed computing environments, where tasks are performed by remote processing devices that are linked through a communications network. In a distributed computing environment, programs may be located in both local and remote memory storage devices.

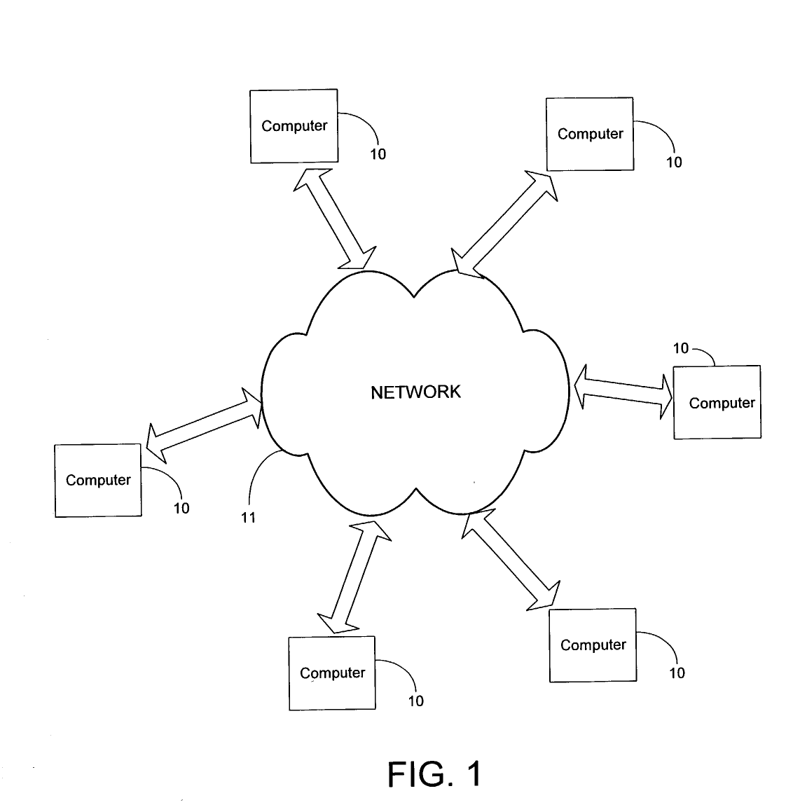

An example of a networked environment in which the invention may be used will now be described with reference to FIG. 1. The example network includes several computers 10 communicating with one another over a network 11, represented by a cloud. Network 11 may include many well-known components, such as routers, gateways, hubs, etc. and allows the computers 10 to communicate via wired and/or wireless media. When interacting with one another of the network 11, one or more of the computers may act as clients, servers or peers with respect to other computers. Accordingly, the various embodiments of the invention may be practiced on clients, servers, peers or combinations thereof, even though specific examples contained herein do not refer to all of these types of computers.

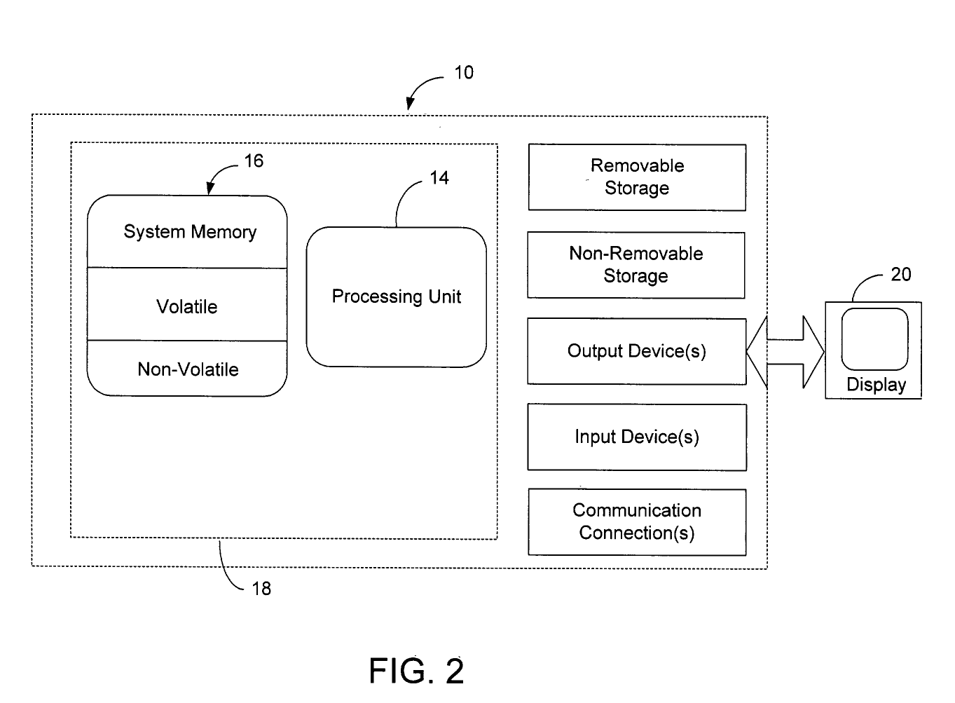

Referring to FIG. 2, an example of a basic configuration for a computer on which all or parts of the invention described herein may be implemented is shown. In its most basic configuration, the computer 10 typically includes at least one processing unit 14 and memory 16. The processing unit 14 executes instructions to carry out tasks in accordance with various embodiments of the invention. In carrying out such tasks, the processing unit 14 may transmit electronic signals to other parts of the computer 10 and to devices outside of the computer 10 to cause some result. Depending on the exact configuration and type of the computer 10, the memory 16 may be volatile (such as RAM), non-volatile (such as ROM or flash memory) or some combination of the two. This most basic configuration is illustrated in FIG. 2 by dashed line 18. Additionally, the computer may also have additional features/functionality. For example, computer 10 may also include additional storage (removable and/or non-removable) including, but not limited to, magnetic or optical disks or tape. Computer storage media includes volatile and non-volatile, removable and non-removable media implemented in any method or technology for storage of information, including computer-executable instructions, data structures, program modules, or other data. Computer storage media includes, but is not limited to, RAM, ROM, EEPROM, flash memory, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 10. Any such computer storage media may be part of computer 10.

Computer 10 may also contain communications connections that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term “computer-readable medium” as used herein includes both computer storage media and communication media.

Computer 10 may also have input devices such as a keyboard, mouse, pen, voice input device, touch input device, etc. Output devices such as a display 20, speakers, a printer, etc. may also be included. All these devices are well known in the art and need not be discussed at length here. Additionally, the display 20 may be one of two, or one of several displays acting as output devices for the computer 10.

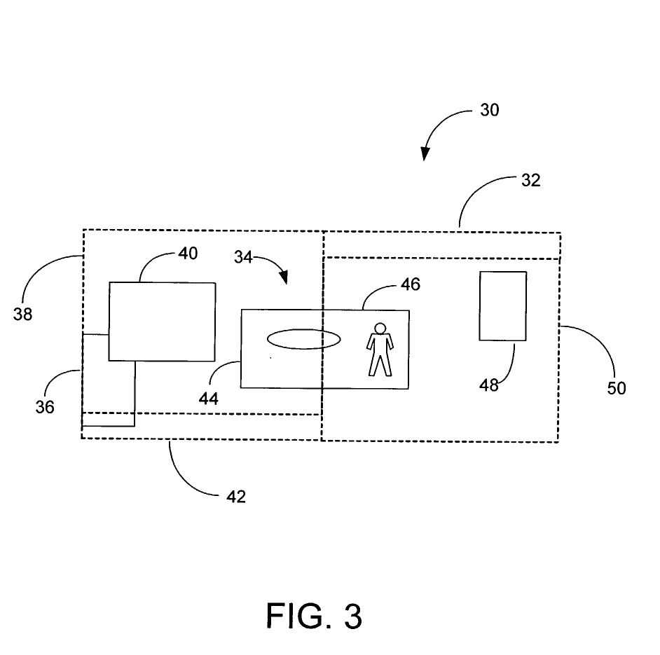

Modern operating systems such as the MICROSOFT WINDOWS® family of operating systems incorporate a user interface that has a notion of defined workspace, some of which may be on-screen and some of which may be off-screen. Referring to FIG. 3, an example of such a workspace is shown. The workspace, which will be referred to hereinafter as a desktop 30, is divided into two logical display areas—a first display area and a second display area. The first display area includes a first on-screen portion 38 and a first off-screen portion 42. The second display area includes a second on-screen portion 50 and a second off-screen portion 32. The first on-screen portion 38 and the second on-screen portion 50 are being displayed on two separate monitors. The desktop 30 also includes four windows 34, 36, 40 and 48, each of which is controlled by a different application program. Specifically, the four windows 34, 36, 40 and 48 are respectively controlled by a first application program, a second application program, a third application program and a fourth application program. As can be seen in FIG. 3 the window 34 of the first application program is split between the first on-screen portion 38 and the second on-screen portion 50 of the desktop 30. Further reference to FIG. 3 will be made in the following paragraphs to help describe various embodiments of the invention.

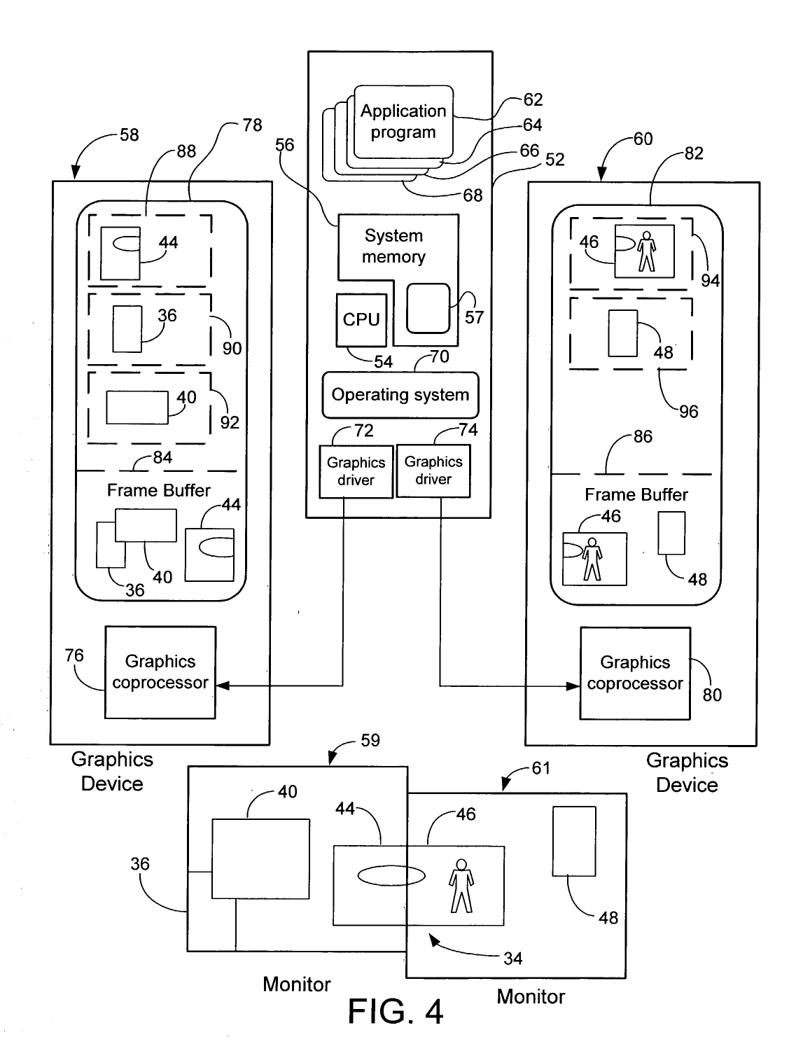

An embodiment of the invention will now be discussed with reference to FIG. 4, in which a computer 52 is shown. The computer 52 includes a central processing unit (CPU) 54 and a system memory 56. The computer 52 communicates with a first graphics device 58, a second graphics device 60, a first monitor 59 and a second monitor 61. Each of the first and second monitors may be implemented in a variety of ways, including a cathode-ray tube device, liquid-crystal display device, and plasma device. The first graphics device 58 controls the operation of the first monitor 59, and the second graphics device 60 controls the operation of the second monitor 61. The first and second graphics devices may be implemented as graphics cards located within the exterior housing of the computer 52. The computer 52 executes one or more programs, including a first application program 62, a second application program 64, a third application program 66 and a fourth application program 68, an operating system 70, a first graphics driver 72 and a second graphics driver 74. The first graphics driver 72 facilitates communication between the operating system 70 and the first graphics device 58, while the second graphics driver 74 facilitates communication between the operating system 70 and the second graphics device 60. The first graphics device 58 includes a graphics coprocessor 76 and a memory 78. The second graphics device 60 likewise includes a graphics coprocessor 80 and a memory 82. Stored in the system memory 56 is a data structure 57. The data structure 57 holds data representing the logical layout of the desktop 30 (FIG. 3) and data regarding the monitors on which each of the first and second on-screen portions 38 and 50 are to be displayed. The data structure 57 also includes the display characteristics of each of the first and second graphics devices 58 and 60, as well as the display characteristics of each of the first and second monitors 59 and 61. These characteristics include color depth, display depth and refresh rate. The operating system 70 populates this data structure by referring to a database or registry and/or making calls to the first and second graphics devices 58 and 60. The data structure 57 may be implemented, for example, as a table.

The memory 78 of the first graphics device 58 includes a frame buffer 84 that functions as both a back buffer (for temporarily holding the contents of the screen of the monitor controlled by the graphics device prior to displaying the contents), and as a front buffer (for holding the contents of the screen during display). Similarly, the memory 82 of the second graphics device 60 also includes a frame buffer 86 that functions as both a front buffer and a back buffer. Each of the memories of the graphics devices also includes backing surfaces, each of which holds part or all of the rendered version of a window controlled by one of the first, second, third or fourth application programs. The memory 78 of the first graphics device 58 includes a first backing surface 88 for holding the rendered version of the first portion 44 of the first application program's window 34, a second backing surface 90 for holding the rendered version of the second application program's window 36 and a third backing surface 92 for holding the rendered version of the third application program's window 40. The memory 82 of the second graphic device 60 includes a first backing surface 94 for holding the rendered version of the second portion 46 of the first application program's window 34 and a second backing surface 96 for holding the rendered version of the fourth application program's window.

An example of how a window that is split across multiple monitors is displayed according to an embodiment of the invention will now be described. In this example, it is assumed that the first application program 62 wishes to display its window 34 at a particular position on the desktop 30. It so happens that the position at which the window 34 is to be displayed will result in the first portion 44 of the window 34 being displayed on the first monitor 59 and the second portion 46 of the window 34 being displayed on the second monitor 61. The first application program 62 sends drawing calls to the operating system 70. The drawing calls include instructions for drawing the window that is associated with the first application program 62, including where on the desktop the window is to be displayed (in terms of coordinates), the dimensions of the window, what images are to be displayed in the window and, in some cases, timing information to indicate when images are to be presented in the window, etc. Based on those instructions, the operating system 70 refers to the data structure 57 to determine which portion of the window will be handled by the first graphics device 58 (and displayed on the first monitor 59), and which portion of the window will be handled by the second graphics device 60 (and displayed on the second monitor 61). The operating system 70 also refers to the data structure 57 determines the display characteristics of the first and second monitors. With the assistance of the first graphics driver 72, the operating system 70 transmits data regarding the contents and layout of the first portion 44 of the first application program's window 34 to the graphics coprocessor 76 of the first graphics device 58. The information is in the form of a set of coordinates or a set of display independent metrics (such as inches or millimeters). Along with the data, the operating system 70 transmits, to the graphics coprocessor 76 of the first graphics device 58, commands for the graphics coprocessor 76 to render the first portion 44 of the window 34. In a similar fashion, and with the assistance of the second graphics driver 74, the operating system 70 transmits data regarding the contents and layout of the second portion 46 of the first application's window 34 to the graphics coprocessor 80 of the second graphics device 60. Along with the data, the operating system 70 transmits, to the graphics coprocessor 80 of the second graphics device 60, commands for the graphics coprocessor 80 to render the second portion 46 of the first application program's window 34.

In response to the commands received from the operating system 70, the graphics coprocessor 76 of the first graphics device 58 renders the first portion 44 of the first application program's window 34 onto the first backing surface 88 of the first graphics device's memory 78. The graphics coprocessor 80 of the second graphics device 60 renders the second portion 46 of the first application program's window 34 onto the first backing surface 94 of the second graphics device's memory 82. The operating system 70 then transmits commands to the graphics coprocessor 76 of the first graphics device 58 via the first graphics driver 72, indicating that the graphics coprocessor 76 should composite the windows that it is maintaining on its backing surfaces into the frame buffer 84 of the first monitor 59. In response, the graphics coprocessor 76 of the first graphics device 58 composites the first portion 44 of the first application program's window 34, the window 36 of the second application program 64 and the window 40 of the third application program 66 into the frame buffer 84 of the first monitor 59. The operating system 70 also transmits commands to the graphics coprocessor 80 of the second graphics device 60 via the second graphics driver 74, indicating that the graphics coprocessor 80 should composite the windows that it is maintaining on its display surfaces into the frame buffer of the second monitor 61. In response, the graphics coprocessor 80 of the second graphics device 60 composites the second portion 46 of the first application program's window 34 and the window 48 of the fourth application 68 into the frame buffer 86 of the second monitor 61. During their normal refresh cycles, the first monitor 59 and the second monitor 61 each retrieve the contents of their respective frame buffers 84 and 86, and display the desktop 30, along with the first and second portions of the first application program's window 34, the second application program's window 36, the third application program's window 40 and the fourth application program's window 48.

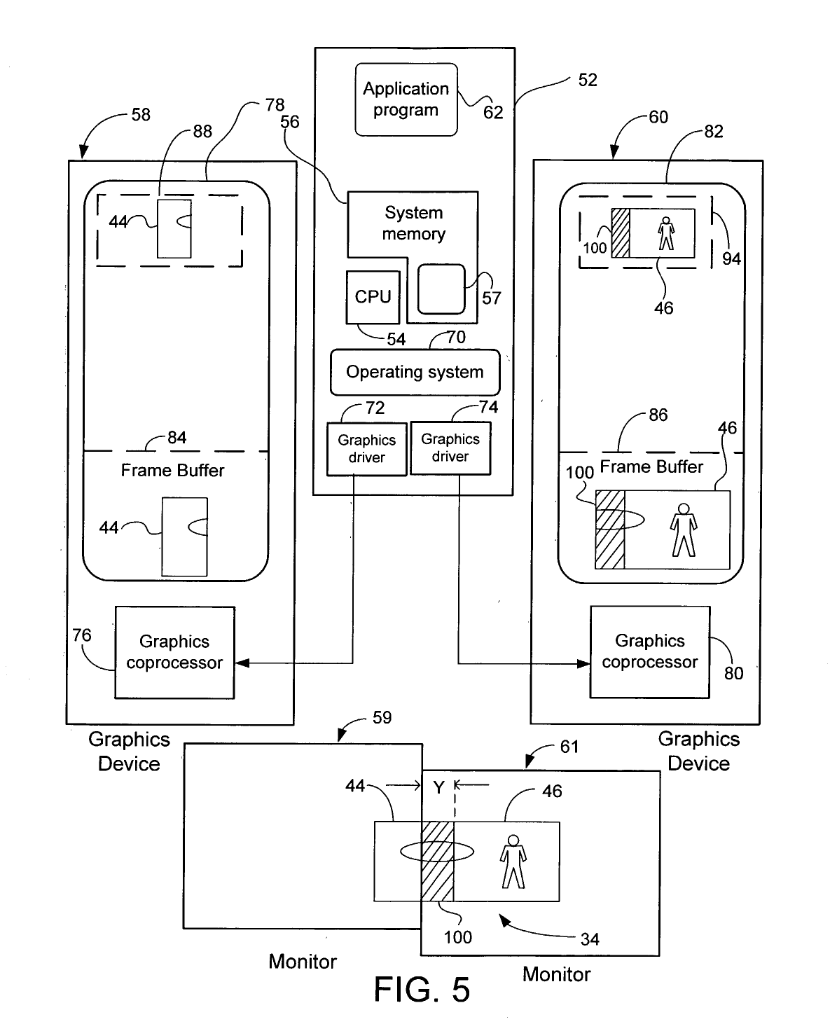

Referring to FIG. 5, an example of a way in which an embodiment of the invention can handle movement of a window will now be described. For the sake of simplifying the example, the only application program shown is the first application program 62, and the only window shown is the first application program's window 34. In this example, it is assumed that the first application program's window 34 moves to the right over a distance of Y. Thus, a middle portion 100 of the window 34 moves from the first monitor 59 to the second monitor 61. One way in which this middle portion 100 can be transferred from the first graphics device 58 to the second graphics device 60 is that the operating system 70 can copy the rendered version of the middle portion 100 to the system memory 56, and then send the rendered version of the middle portion 100 to the graphics coprocessor 80 of the second graphics device 60 along with instructions on where to append the middle portion 100 to the image data that is already in the first backing surface 94 of the second graphics device 60.

Continuing with FIG. 5, another approach to handling the movement of the first application program's window 34 is for the operating system 70 to inform both the first graphics device 58 and the second graphics device 60 that the window 34 has moved, and what its new coordinates are, but to wait for the first application program to initiate a redrawing of the window 34. The first application program 62 may initiate a redrawing of the window 34 on its own, as part of a regularly scheduled refresh, or may be prompted by the operating system 70, which may send a “paint” request to the first application program 62. The result of this approach is that the first and second graphics devices re-render and re-composite the window 34 to account for the movement, but since the second graphics device 58 does not have any information regarding the middle portion 100, it leaves the middle portion 100 of the window 34 blank. Once the first application program 62 issues a call to redraw the window, the operating system 70 provides updated rendering information to the second graphics device 60, including the contents of the middle portion 100. Preferably, the period of time between the movement of the window 34 and the redrawing operation initiated by the first application program 62 is short enough that a user will not notice the temporary blank spot where the middle portion 100 is supposed to be.

Referring again to FIG. 5, another approach of how movement of the first application program's window 34 may be handled will now be described. According to this approach, when the first application program 62 sends a command to the operating system 70 to move the window 34, the operating system 70 does not immediately send rendering commands to the first and second graphics devices, but rather sends a message to the first application program 62 requesting that the first application program 62 update its window 34. The first application program 62 then makes drawing calls to the operating system 70, and provides all of the information needed to re-render the window 34, or provides a least enough information to fill in the middle portion 100. The operating system 70 then, as described in conjunction with FIG. 4, transmits information regarding the newly defined first and second portions 44 and 46 of the window 34 to the graphics coprocessors of the respective first and second graphics devices 58 and 60. The resulting shifted window is then displayed on the first and second monitors, with the middle portion 100 being properly shifted to the second monitor 61. Since the operating system 70 did not immediately inform the first and second graphics devices regarding the movement of the first application program's window 34, there may be a slight delay between the time that window was supposed to move (as a result of a user clicking and dragging it, for example) and when it actually is shown to move on the first and second monitors. Preferably, this delay is small enough as to be imperceptible to the user. Furthermore, this approach is preferably used in situations where the operating system 70 has control over when the first application program 62 takes action.

Referring once again to FIG. 5, yet another technique for handling the movement of a window from one monitor to another will now be described. According to this technique, the operating system 70 attempts to predict the movement of the window and to provide to the appropriate graphics device advance notice about what part of the window it will be responsible for displaying. For example, if the operating system 70 predicts that the first application program's window 34 will move as shown in FIG. 5, then the operating system 70, without being prompted by the first application program 62, transmits information regarding the middle portion 100 of the window 34 to the graphics coprocessor 80 of the second graphics device 60, along with instructions for the graphics coprocessor to render the middle portion 100. If, as the operating system 70 predicted, the first application program 62 does, in fact, move its window 34 in the predicted direction, then the operating system 70 only needs to instruct the graphics coprocessor 80 of the second graphics device 60 to composite the rendered image. If the first application program 62 does not move its window 34 as predicted by the operating system 70, then the operating system 70 does not instruct the graphics coprocessor 80 of the second graphics device 60 to composite the image, but rather reverts to one of the other approaches previously discussed to obtain the correct rendering information for the first application program's window 34.

In a variation of the technique described in the previous paragraph, the operating system 70, rather than predicting the movement of the window 34, keeps an extra copy of the middle portion 100 of the window 34 in the backing surface 94, obtained from when the first application program 62 last rendered the window 34. The extra copy may include parts of the window 34 beyond the middle portion 100. For example, the extra copy could include a section of the window 34 that is two times the width Y, yet still includes the middle portion 100.

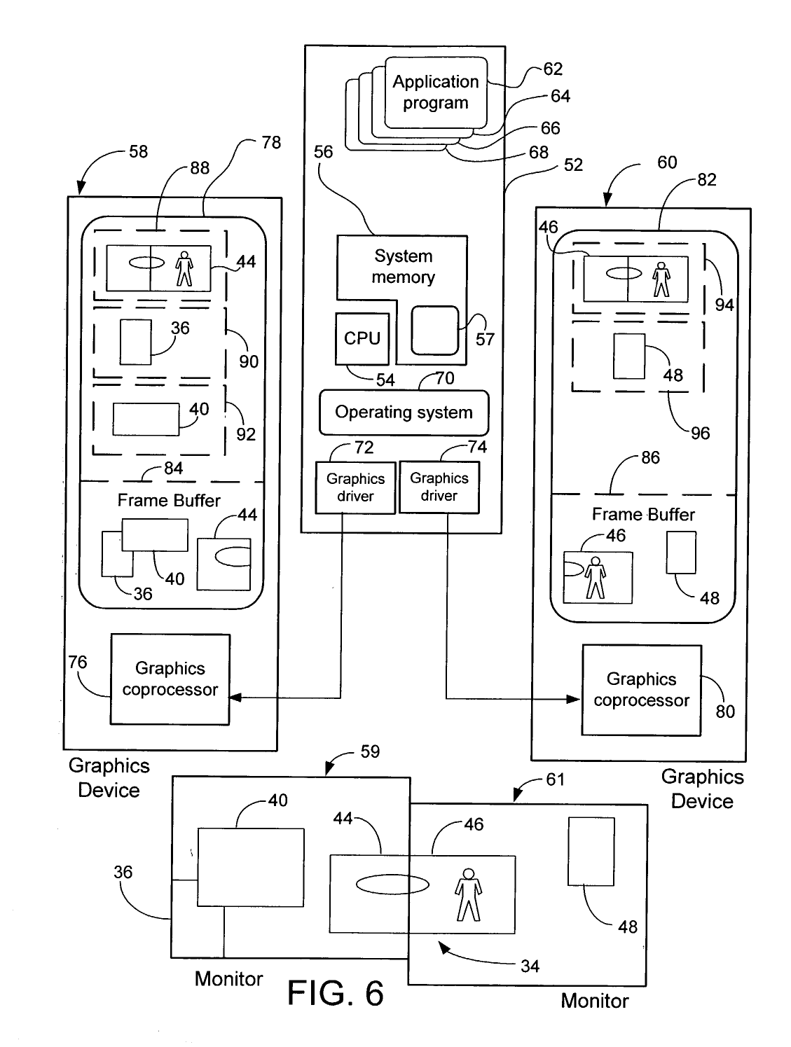

Referring to FIG. 6, an example of how the system of FIG. 4 displays a window across multiple monitors in another embodiment of the invention will now be described. In this example, the procedure is the same as that described in conjunction with FIG. 5, except that the operating system 70 transmits information about the entire window 34 of the first application program 62 both to the graphics coprocessor 76 of the first graphics device 58 and to the graphics coprocessor 80 of the second graphics device 60, along with clipping information to indicate how much of the window 34 each graphics device is responsible for rendering and compositing. Note that, unlike in FIG. 4, the first backing surface 88 of the first graphic device's memory 78 and the first backing surface 94 of the second graphic device's memory 82 each have information regarding the entire window 34 of the first application program 62. While this embodiment uses up more of the memory of the graphics devices than the previous embodiment, it accommodates movement of the window 34 of the first application program. For example, if the window 34 moves from left to right, such that the boundary between the portion displayed on the first monitor and the portion displayed on the second monitor is now at point X (FIG. 3), the operating system 70 does not need to issue a full set of rendering commands to the first and second graphics devices, but need only transmit information regarding the new location of the boundary. Since each of the first and second graphics devices 58 and 60 already has the information needed to render the first application's entire window, it only needs to know how much of the window should be displayed on the monitor that it controls.

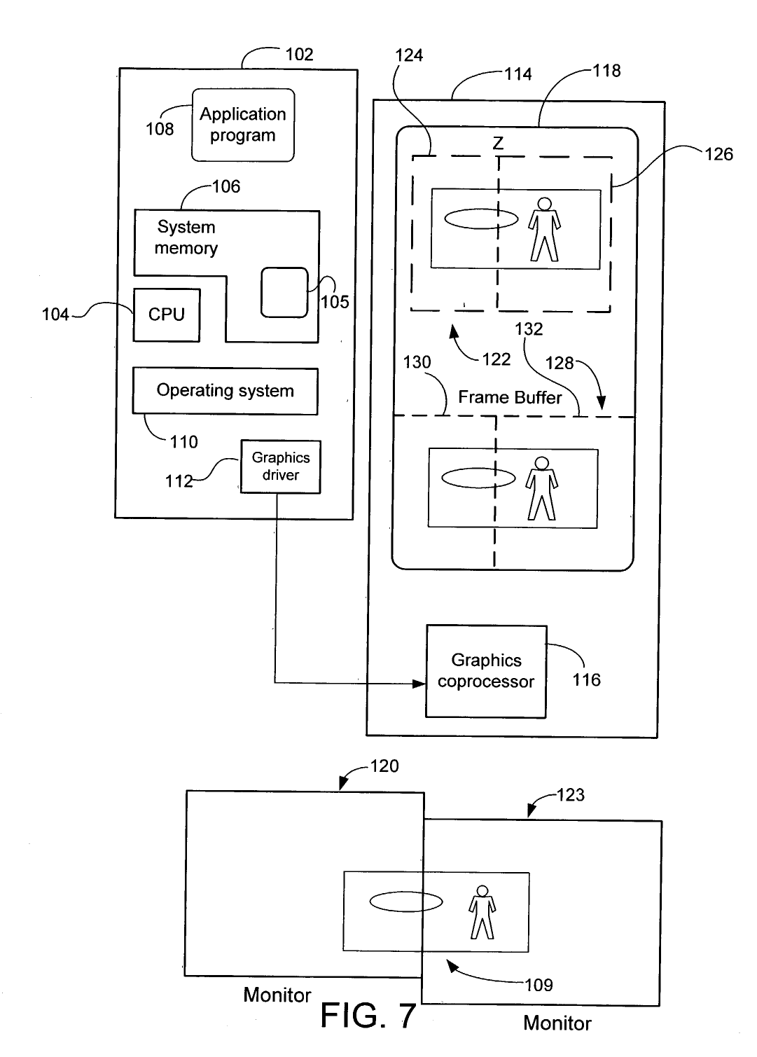

Referring to FIG. 7, an alternative embodiment of the invention will now be described. Depicted in FIG. 7 is a computer 102 having a central processing unit (CPU) 104, and a system memory 106. The computer 102 executes an application program 108, an operating system 110 and a graphics device driver 112. The computer 102 is in communication with a graphics device 114, which may be physically located within the housing of the computer 102. The graphics device 114 has a graphics coprocessor 116 and a memory 118. The computer 102 is communicatively linked to a first monitor 120 and a second monitor 123, which are both controlled by the graphics device 114. The graphics device 114 may be implemented as a so-called “dual headed” graphics card. The memory 118 of the graphics device 114 has a backing surface 122 that has a boundary Z that logically partitions the backing surface 122 into two sections—a first section 124 for rendered windows that are to be displayed on the first monitor 120 and a second section 126 for rendered windows that are to be displayed on the second monitor 123. The memory 118 also includes a frame buffer 128 that is logically partitioned into a first section 130 for composited windows that are to be displayed on the first monitor 120 and a second section 132 for composited windows that are to be displayed on the second monitor 123. According to this embodiment of the invention, the first and second sections of the backing surface 122 are contiguous, in terms of addressing, with one another. According to this embodiment of the invention, the operating system 110, when handling requests from the application program 108 to display, move and/or change the contents of the window, treats the first and second monitors as if they are a single device. This is based on the fact that they are controlled by a single graphics device. When the application program 108 makes drawing calls to the operating system 110, the operating system 110 sends rendering data for the entire window 109 of the application program 108 to the graphics coprocessor 116 (via the graphics device driver 112). The operating system 110 also indicates to the graphics coprocessor 116 where the logical boundary is between the portion of the window 109 that is to be displayed by the first monitor 120 and the portion of the desktop that is to be displayed by the second monitor 123. The graphics coprocessor 116 renders the entire window 109 of the application program 108 in the backing surface 122 of the memory 118, such that the portion of the window that is to be displayed on the first monitor 120 is rendered onto the first portion 124 of the backing surface 122 and the portion of the window that is to be displayed on the second monitor is rendered onto the second portion 126 of the backing surface. Thus, if the window 109 moves, the operating system need only provide the graphics coprocessor with information regarding the new coordinates of the window 109 on the desktop. The graphics coprocessor 116 uses this information to relocate the window on the backing surface 122 and to make other adjustments as necessary. For example, if the window 109 moves to the right, such that the portion of it that appears on the first monitor 120 decreases and the portion of it that appears on the second monitor 123 increases, the graphics coprocessor 116 need only change the location of the boundary Z in the backing surface 122, moving it to the “left” logically to match the movement of the window 109.

In the embodiment of the invention described above in conjunction with FIG. 7, the operating system 110 may need to account for differences in the display characteristics between the first monitor 120 and the second monitor 123. For example, if the first monitor 120 has a display resolution of 96 bits per pixel, and the second monitor 123 has a display resolution of 32 bits per pixel, then the rendering instructions that the operating system 110 sends to the graphics coprocessor 116 include scaling information that allows the graphics coprocessor 116 to scale the window such that the portion that appears on the first monitor 120 has three times the resolution that the portion of the window that appears on the second monitor 123 has. The operating system 110 obtains information regarding the two monitors 120 and 123 from a data structure 105. As with the previously described embodiments, the data structure 105 may be populated based on entries in a database or registry and/or based on information received directly from the graphics device 114.

It can thus be seen that a new and useful method and system for displaying images on multiple monitors has been provided. In view of the many possible embodiments to which the principles of this invention may be applied, it should be recognized that the embodiments described herein with respect to the drawing figure is meant to be illustrative only and should not be taken as limiting the scope of invention. For example, those of skill in the art will recognize that a graphics driver may facilitate communication with multiple monitors such that the embodiments shown in FIGS. 4-6 may be implemented using a single graphics driver, or implemented with additional monitors controlled by the two drivers depicted. In another example, the frame buffers depicted in FIGS. 4-7 do not have to have back buffers. In yet another example, the graphics devices depicted in FIGS. 4-7 may have two backing surfaces for each window to enable each application program to update its window at a different rate than corresponding graphics processor consumes it.

Finally, those of skill in the art will recognize that the elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims are equivalents thereof.

I claim:

1. A method for displaying images on a plurality of monitors comprising a first monitor and a second monitor the method comprising:
maintaining, in a memory of a computer that is communicatively linked to the first and second monitors, information regarding which portion of a window is to be displayed on the first monitor and information regarding which portion of the window is to be displayed on the second monitor;
delegating, to a first graphics processor, the task of rendering the portion of the window that is to be displayed on the first monitor; and
delegating, to a second graphics processor, the task of rendering the portion of the window that is to be displayed on the second monitor,
wherein the first and second graphics processors perform their respective tasks of rendering the respective portions of the window in parallel with one another.

2. A computer-readable medium having stored thereon computer-executable instructions for performing the method of claim 1.

3. The method of claim 1, wherein the computer has a central processing unit, the method further comprising:
creating a first set of image data based on the portion of the graphical workspace is to be displayed on the first monitor;
creating a second set of image data based on the portion of the graphical workspace is to be displayed on the second monitor;
the first graphics processor rendering, without assistance from the central processing unit, at least one image of the window based on the first set of image data; and
the second graphics processor rendering, without assistance from the central processing unit, at least one image of the window based on the second set of image data.

4. The method of claim 3,
wherein the first set of image data only includes data regarding the portion of the window that is to be displayed on the first monitor, and
wherein the second set of image data only includes data regarding the portion of the window that is to be displayed on the second monitor.

5. The method of claim 3, wherein
each of the first and second sets of data comprises data regarding the contents of the entire window and data describing the boundary between the contents that are to be displayed on the first monitor and the contents that are to be displayed on the second monitor.

6. The method of claim 1, further comprising:
the first coprocessor rendering, onto a memory, the portion of the window that is to be displayed on the first monitor; and
the second coprocessor rendering, onto a memory, the portion of the window that is to be displayed on the second monitor.

7. The method of claim 1, wherein the computer has a system memory, wherein the first coprocessor is part of a first graphics device, the first graphics device comprising a memory that is distinct from the system memory, wherein the second coprocessor is part of a first graphics device, the second graphics device comprising a memory that is distinct from the system memory the method further comprising:
the first coprocessor rendering, onto the memory of the first graphics device, the portion of the window that is to be displayed on the first monitor; and
the second coprocessor rendering, onto the memory of the second graphics device, the portion of the window that is to be displayed on the second monitor.

8. The method of claim 7, wherein the memory of the first graphics device comprises a backing surface for temporarily storing a rendered version of the portion of the window that is to be displayed on the first monitor, and a frame buffer for storing a composited version of the portion of the window that is to be displayed on the first monitor, wherein the memory of the second graphics device comprises a backing surface for temporarily storing a rendered version of the portion of the window that is to be displayed on the second monitor, and a frame buffer for storing a composited version of the portion of the window that is to be displayed on the second monitor, the method further comprising:
the first graphics coprocessor compositing the portion of the window that is to be displayed on the first monitor into the frame buffer of the first graphics device's memory; and
the second graphics coprocessor compositing the portion of window that is to be displayed on the second monitor into the frame buffer of the second graphics device's memory.

9. The method of claim 8, wherein the backing surface and the frame buffer are located in the same physical memory as a system memory of the computer.

10. The method of claim 1, further comprising:
receiving an indication that the window is to be moved so that a portion of the window that had previously been displayed on the first monitor is now to be displayed on the second monitor; and
sending, to the second graphics coprocessor, data representing the portion of the window that is to be moved from the first monitor to the second monitor.

11. The method of claim 10, wherein the computer has a system memory, wherein the first coprocessor is part of a first graphics device, the first graphics device comprising a memory that is distinct from the system memory wherein the second coprocessor is part of a first graphics device, the second graphics device comprising a memory that is distinct from the system memory the method further comprising:
the first graphics coprocessor rendering, onto the memory of the first graphics device, the portion of the window that is to be displayed on the first monitor, not including the portion of the window that is to be moved; and
the second graphics coprocessor rendering, onto the memory of the second graphics device, the portion of the window that is to be displayed on the second monitor, including the portion of the window that is to be moved.

12. The method of claim 1, wherein the computer has a system memory, wherein the first coprocessor is part of a first graphics device, the first graphics device comprising a memory that is distinct from the system memory, wherein the second coprocessor is part of a first graphics device, the second graphics device comprising a memory that is distinct from the system memory the method further comprising:
the first coprocessor rendering, onto a backing surface of the memory of the first graphics device, the portion of the window that is to be displayed on the first monitor; and the second coprocessor rendering, onto the memory of the second graphics device, the portion of the window that is to be displayed on the second monitor;
the first coprocessor rendering one or more other windows onto one or more other backing surfaces of the memory of the first graphics device;
the second coprocessor rendering, onto the memory of the second graphics device, the portion of the window that is to be displayed on the second monitor; and
the second coprocessor rendering one or more other windows onto one or more other backing surfaces of the memory of the second graphics device.

13. The method of claim 1, wherein the plurality of monitors further comprises a third monitor, the method further comprising:
maintaining, in the memory, information regarding which portion of the window is to be displayed on the third monitor; and
delegating, to a third graphics processor, the task of rendering the portion of the window that is to be displayed on the third monitor.

14. The method of claim 1, wherein the plurality of monitors further comprises multiple monitors in addition to the first and the second monitors, the method further comprising:
delegating, to one or more other graphics processors, the task or tasks of rendering the portion or portions of the window that are to be displayed by the multiple monitors.

15. On a computer system comprising a main processor for executing one or more application programs and at least a first and a second monitor, a method for displaying a window across the first and second monitors, the method comprising:
delegating, to a graphics device, the task of rendering the window, the graphics device comprising a graphics coprocessor that is separate from the main processor, and a memory, the memory comprising a first area for storing rendered images that are to be displayed on the first monitor, a second area for storing rendered images that are to be displayed on the second monitor and a boundary between the first and second areas; and
the graphics coprocessor rendering the window in the memory of the graphics device such that the portion of the window that is to be displayed on the first monitor is stored in the first area, and the portion of the window that is to be displayed on the second monitor is stored in the second area.

16. The method of claim 15, further comprising the main processor sending, to the graphics device, data regarding a change in an address of the boundary, the change being representative of a movement of the window.

17. The method of claim 15, further comprising:
detecting that the window is to be moved, such that at least some of the portion of the window that was originally meant to be displayed on the first monitor will now be displayed on the second monitor;
in response to the detecting step, sending information regarding the movement of the window to the graphics device; and
the graphics device changing a memory address of the boundary based on the information.

18. A system for displaying images, the system comprising:
a computer comprising a central processing unit and a memory;
a plurality of graphics coprocessors comprising a first graphics coprocessor and a second graphics coprocessor;
a plurality of monitors comprising a first monitor controlled by the first graphics coprocessor and a second monitor controlled by the second graphics coprocessor; and
the memory having stored thereon data, the data comprising information regarding how a window is organized,
wherein the central processing unit performs steps comprising:
prior to the window being rendered, transferring at least some of the information to the first graphics coprocessor, and
prior to the window being rendered, transferring at least some of the information to the second graphics coprocessor.

19. The system of claim 18, further comprising:
a first graphics card that includes the first graphics coprocessor and comprises a memory;
a second graphics card that includes the second graphics coprocessor and comprises a memory,
wherein the first graphics device renders a portion of the window that is to appear on the first monitor in the memory of the first graphics device, and
wherein the second graphics device renders a portion of the window that is to appear on the second monitor in the memory of the second graphics device.

20. The system of claim 19, wherein the central processing unit performs further steps comprising:
sending to the second graphics device data regarding a portion of the window that is being moved from the first monitor to the second monitor.

21. A system for displaying images on multiple monitors, the system comprising:
a computer comprising a system memory, the computer executing at least one application program, the system memory having stored therein data describing a window through which the application program interacts with a user;
a plurality of graphics cards comprising at least a first graphics card and a second graphics card; and
a plurality of computer monitors comprising at least a first monitor and a second monitor, the first monitor being controlled by the first graphics card, the second monitor being controlled by the second graphics card;
wherein the computer transfers data regarding the window to both the first and the second graphics cards in parallel without rendering the window in the system memory,
wherein the first graphics card renders a first part of the window that is to appear on the first monitor and enters the rendered first part of the window into a frame buffer associated with the first monitor, and
wherein the second graphics card renders a second part of the window that is to appear on the second monitor and enters the rendered second part of the window into a frame buffer associated with the second monitor.

22. The system of claim 21,
wherein the first graphics card comprises a memory, the memory comprising a backing surface for holding the rendered first part of the window, and
wherein the second graphics card comprises a memory, the memory comprising a backing surface for holding the rendered second part of the window.

23. The system of claim 21, wherein the first and second graphics cards each have a memory comprising a backing surface for holding the first and second rendered parts of the window.

24. The system of claim 21,
wherein the window is one of a plurality of windows,
wherein at least one of the first and second graphics devices comprises a memory having a plurality of backing surfaces, each backing surface holding a rendered portion of one of the plurality of windows.

25. A method for displaying a workspace on a plurality of monitors, the workspace comprising a plurality of display areas and one or more windows, the plurality of monitors acting as output devices for a computer, the plurality of monitors being under control of a plurality of graphics devices coupled to the computer, the method comprising:
determining a logical organization for the display areas on the plurality of monitors mapping the display areas to one or more frame buffers of the plurality of graphics devices;
determining which display or displays each window of the one or more windows affects; and
for each window of the one or more windows, when the rendering instructions for the window are being processed, routing the rendering instructions to the plurality of graphics devices such that each of the graphics devices receives a portion of the rendering instructions in parallel with the other graphics devices.

26. A computer-readable medium having stored thereon computer-executable instructions for performing the method of claim 25.
